(19) United States
(12) Patent Application Publication
(10) Pub. No.: US 2013/0148358 A1
(43) Pub. Date: Jun. 13, 2013

(54) Detachable cover apparatus for compact fluorescent light (CFL) bulbs that affects illumination clarity, quality and color

(71) Applicant: Hooshmand Harooni, Los Angeles, CA (US)

(72) Inventor: Hooshmand Harooni, Los Angeles, CA (US)

(21) Appl. No.: 13/312,995

(22) Filed: Dec. 7, 2011

(51) Int. Cl. F21V 14/00

(52) U.S. Cl. 362/255

(57) ABSTRACT

This invention describes a detachable cover apparatus for a compact fluorescent light (CFL) light bulb (hereinafter “Detachable CFL Cover”) that affects illumination diffusion, quality, and color. The cover apparatus is slipped over the light emitting portion of the CFL light and attached to the base of the bulb. Upon attachment, the Detachable CFL Cover provides the ability to diffuse or soften, reflect, or change the color of the light emitted from the CFL bulb for practical utilitarian or cosmetic purposes. The Detachable CFL Cover is pressure-mounted to the CFL bulb, hence is detachable, and interchangeable with other Detachable CFL Covers to provide a multitude of illumination options from a single CFL light source.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### SUMMARY OF THE INVENTION

In view of the foregoing, this patent application provides for a Detachable Cover Apparatus for Compact Fluorescent Light (CFL) Light Bulbs that serves to alter the illumination properties of the light source.

The use or fluorescent lighting over traditional incandescent lighting sources has increased over time due to several factors. In general, fluorescent lighting systems utilize less energy, create less heat, and last substantially longer than incandescent light bulbs. However, fluorescent lighting has some disadvantages when compared to other light sources including providing an illumination that many consider more harsh than incandescent light bulbs. The Detachable Cover Apparatus for CFL light bulbs described in this application provides multiple alternatives to control the illumination characteristics including harshness.

More specifically, the CFL cover, being manufactured of highly heat resistant material, can be slipped over the CFL bulb and not only fastened to the base of the bulb but also held in place using a pressure applying framework that both provides structure to the Detachable CFL Cover as well to provide additional stability by being pressure-mounted and applying light pressure onto the exterior surface of the CFL light bulb itself.

Once in place, the Detachable CFL Cover can diffuse or soften the quality of light provided for by the CFI cover, or alternately change the hue or color of the emitted light by creating a multitude of illumination improvements for many diverse applications. Some examples of this include but are not limited to creating less harsh and softer lighting conditions for both residential and commercial applications, improving detailed personal lighting applications such as reading or makeup application, and for creating ambient lighting conditions in the photography and videography markets.

In addition, in many applications, CFL bulbs are larger in size to provide for increased illumination, but in these circumstances the physical size of the CFL bulbs results in the bulbs being placed in light sockets without fixtures, creating an aesthetically displeasing effect. This is often also true for smaller CFL bulbs placed in fixtures due to the shape and spiral nature of the fluorescent tubing. In both of these situations the CFL cover apparatus described. in this application enables users to cover the CFL bulb to counter and remove this displeasing effect.

As mentioned, the Detachable Cover Apparatus for CFL Light Bulbs is comprised of a cover material that must be heat resistant. One such example of the material that could be used is tough spun, a heat resistant pliable material commonly used for light diffusion in conjunction with photographic purposes. Early versions of tough spun were manufactured from a fiberglass based weave material, more recent versions have been plastics-based.

In this invention, the cover material is attached to a rigid frame structure, which in the case of a cover made of a pliable material, provides stability and a fixed form to the CFL cover. This rigid frame structure is also attached to a set of additional mountings, most often but not necessarily limited to three, that are used to mount the CFL cover to the CFL bulb by applying pressure directly to the exterior portions of the fluorescent tubing to hold the cover in place. This mounting mechanism provides for the core of this application.

In one embodiment of the Detachable Cover Apparatus for CFL light bulbs, the cover material is comprised of a material that provides for a diffusion or softness of the fluorescent light source. The degree of diffusion or softness provided will be proportional to the opaqueness or transparency of the material used as well as the tightness of its weave. In this embodiment the light emanating from the fluorescent light is both bouncing off the interior surface of the cover as well as being dispersed as it travels through the weave of the material, causing the diffusion or softness to occur.

In another embodiment of the Detachable Cover Apparatus for the CFL light bulbs, the cover material is comprised of a material that serves to change the color of the emitted illumination. As the light travels through the color changing CFL cover, the white light emitted by the phosphor in the interior of the fluorescent tubing acquires the color characteristics of the CFL cover itself.

In another embodiment of the Detachable Cover Apparatus for the CFL light bulbs, the cover material is comprised of a material that effectively serves to reflect the illumination from the fluorescent light source in specific direction. In one variation of this embodiment one half of the interior surface of the CFL cover could be made of a light reflective material, causing the reflection of the light source to travel in the direction opposite to the reflective material surface. In another variation of this embodiment, the reflective material could be attached to the supporting rigid structure of the Detachable Cover Apparatus for the CFL, but be attached perpendicular to the axis of the fluorescent tubing, thereby reflecting the light directly away from the surface of said reflective material.

Using the various embodiments documented above, it can be seen that the Detachable Cover Apparatus for CFL bulbs invention will serve to alter the lighting conditions of a compact fluorescent light source by altering its softness, its color, or the beam direction.

### BRIEF DESCRIPTION OF THE DRAWINGS

FIG. 1 A diagram depicting the exterior of the Detachable Cover Apparatus For Compact Fluorescent Light (CFL) Bulbs being slipped over the CFL bulb.

FIG. 2 A diagram depicting a variation of FIG. 1, but with the front portion of the exterior cover removed to provide a cutaway view.

FIG. 3 A diagram depicting the Detachable Cover Apparatus For Compact Fluorescent Light (CFL) Bulbs as pulled completely over the fluorescent light tubes, showing both a top view and a head on view.

FIG. 4 A diagram depicting the only the rigid interior structure of the Detachable Cover Apparatus For Compact Fluorescent Light (CFL) Bulbs, without the cover attached.

FIG. 5 A variation of FIG. 4, showing a portion of the CFL cover attached with a cutaway view.

FIG. 6 An exterior view of the Detachable Cover Apparatus For Compact Fluorescent Light (CFL) Bulbs invention.

### DETAILED DESCRIPTION OF THE INVENTION

The Detachable Cover Apparatus For Compact Fluorescent Light (CFL) Bulbs described in this application therefore provides a unique ability to provide varying light treatments to a compact fluorescent light source in a single frame apparatus that fits snugly over the fluorescent tubes of the CFL using a unique pressure mounting mechanism. The outside cover or casing material dictates the nature of treatment that is effected on the fluorescent light source, and can be manufactured using either a pliable or non-pliable material so long as it provides heat resistant properties sufficient to withstand the minimal heat released from the compact fluorescent light bulb.

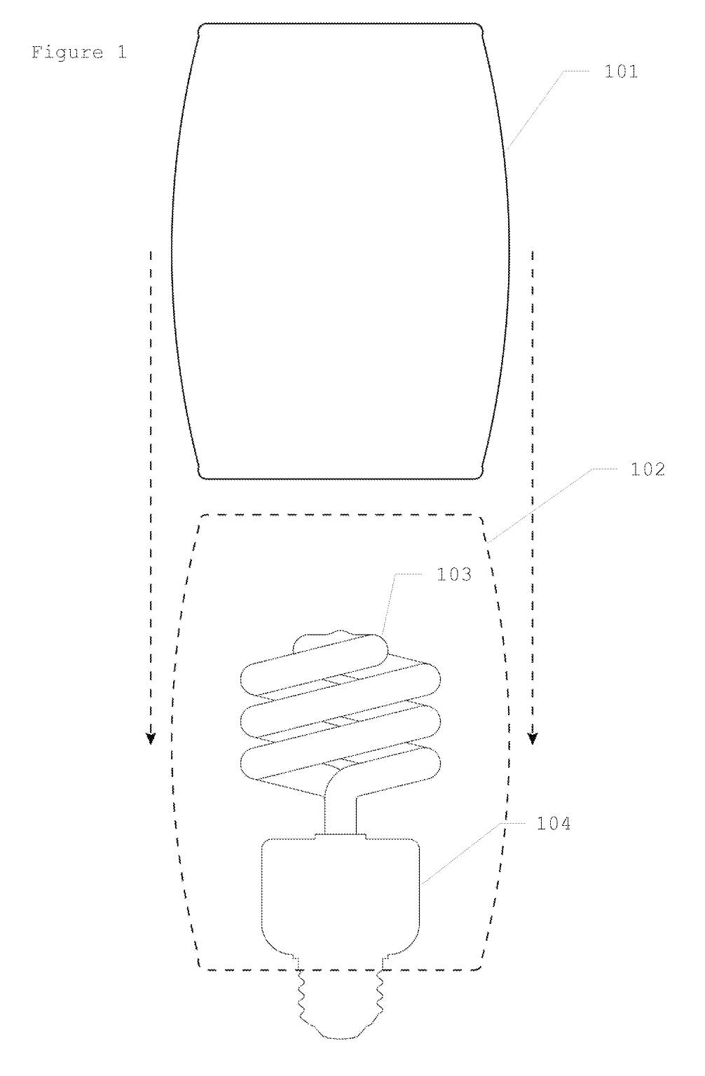

FIG. 1 depicts the Detachable Cover Apparatus For Compact Fluorescent Light (CFL) Bulbs being pulled over the outside of the CFL. 101 depicts the exterior cover or casing of the CFL cover apparatus, with 102 showing the outline of the Detachable Cover Apparatus For Compact Fluorescent Light (CFL) Bulbs device when it is completely pulled over the CFL. 103 shows the fluorescent tube section of the CFL (the light emitting source), and 104 depicts the base of the CFL. Note that the Detachable Cover Apparatus for Compact Fluorescent Light (CFL) Bulbs device does not extend past the base of the CFL bulb.

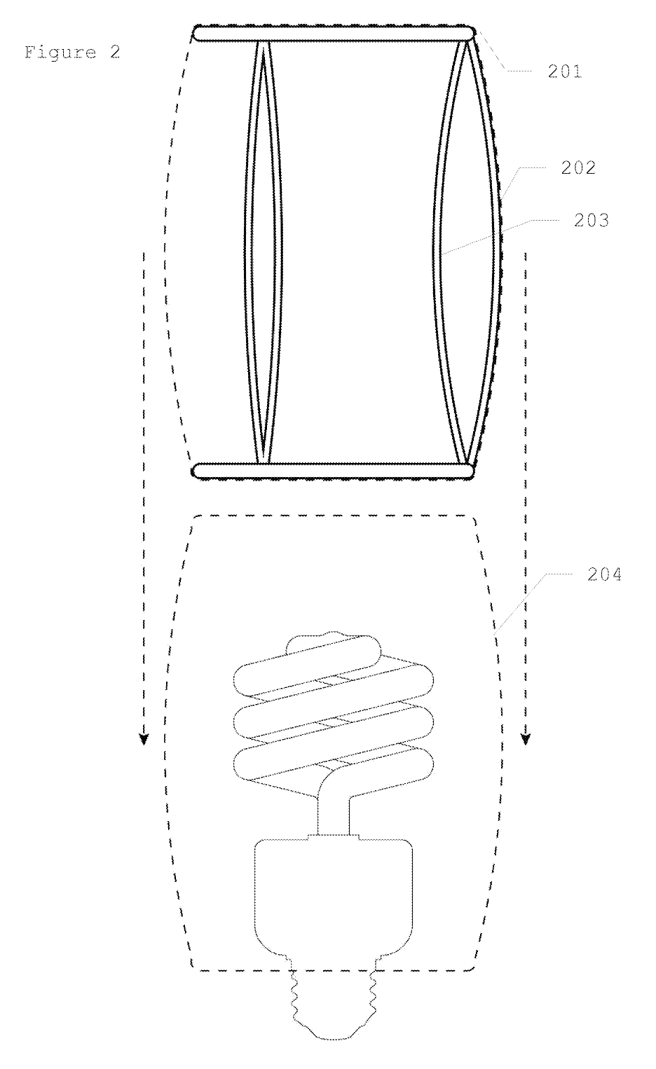

FIG. 2 shows another view into the diagram shown in FIG. 1 with the exception of showing the rigid framework of the Detachable Cover Apparatus For Compact Fluorescent Light (CFL) Bulbs device. 201 shows the rigid structure holding the form of the Detachable Cover Apparatus For Compact Fluorescent Light (CFL) Bulbs device, with a solid ring or other closed loop shape at both the top and bottom of the device. 202 shows one of the outside rigid framework support that holds the shape of the CFL cover, and 203 shows the inside rigid framework that holds the entire invention in place by applying pressure to the exterior edges of the fluorescent tubes of the CFL bulb. Again, 204 shows the Detachable Cover Apparatus For Compact Fluorescent Light (CFL) Bulbs device as pulled completely over to the base of the CFL bulb.

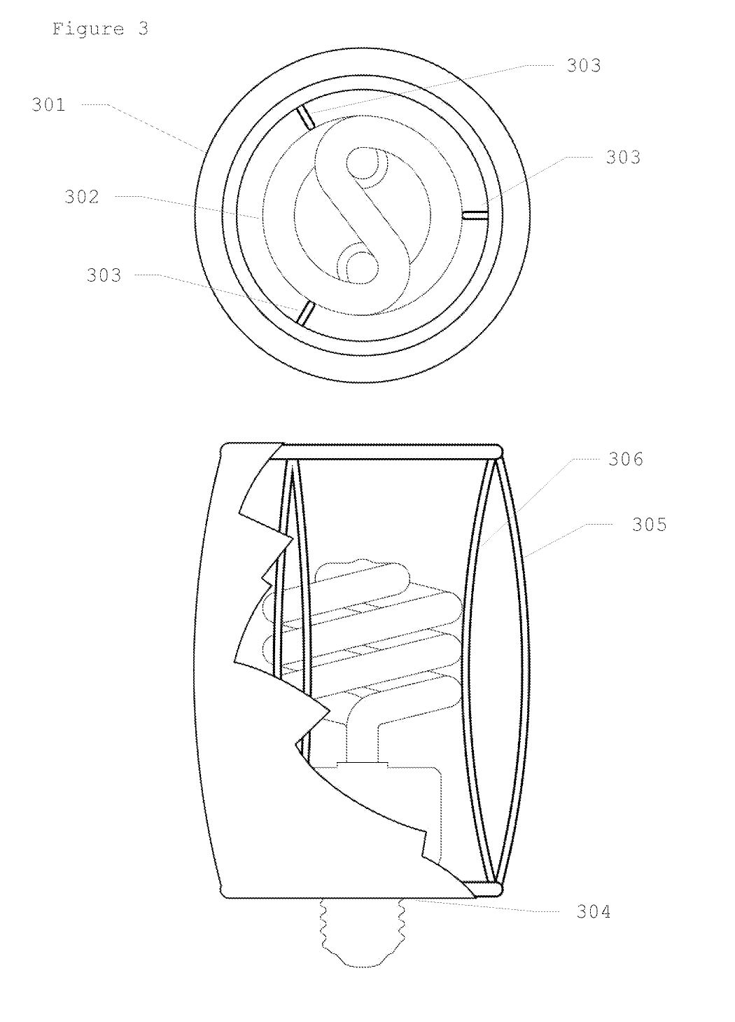

FIG. 3 depicts two views of the Detachable Cover Apparatus For Compact Fluorescent Light (CFL) Bulbs invention. The upper diagram shows a top view of the Detachable Cover Apparatus For Compact Fluorescent Light (CFL) Bulbs device, with the optional top portion of the CFL cover cutaway. 301 depicts the outside edge of the CFL cover, the three points 303 show the inside portion of the rigid structure of the device making contact with and applying pressure to the surface of the fluorescent tubes 302 in order to hold the entire invention in place. FIG. 3 depicts a three point pressure system, but optionally the Detachable Cover Apparatus For Compact Fluorescent Light (CFL) Bulbs device could contain 4, 5, or more legs in the rigid structure in order to maintain the CFL cover in place. The lower portion of FIG. 3 depicts the CFL cover as pulled over the CFL bulb up to the base of the bulb 304. 305 depicts the outer portion of the rigid structure holding the shape of the pliable cover, and 306 shows the interior portion of the rigid structure contacting the fluorescent tubes directly and holding the entire CFL cover in place.

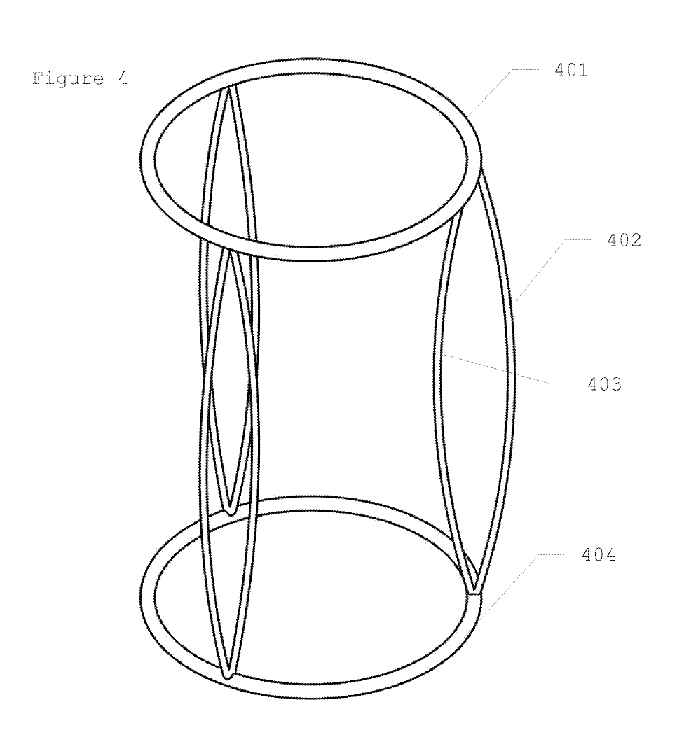

FIG. 4 shows the interior structure of the Detachable Cover Apparatus For Compact Fluorescent Light (CFL) Bulbs device. 401 shows the top rigid portion of the interior structure, and 404 depicts the bottom portion of same. 402 shows the exterior portion of the rigid structure that holds the form of the CFL cover material, and 403 shows the interior portion of said rigid structure that makes contact with the fluorescent tubes to keep the device in place on the CFL bulb.

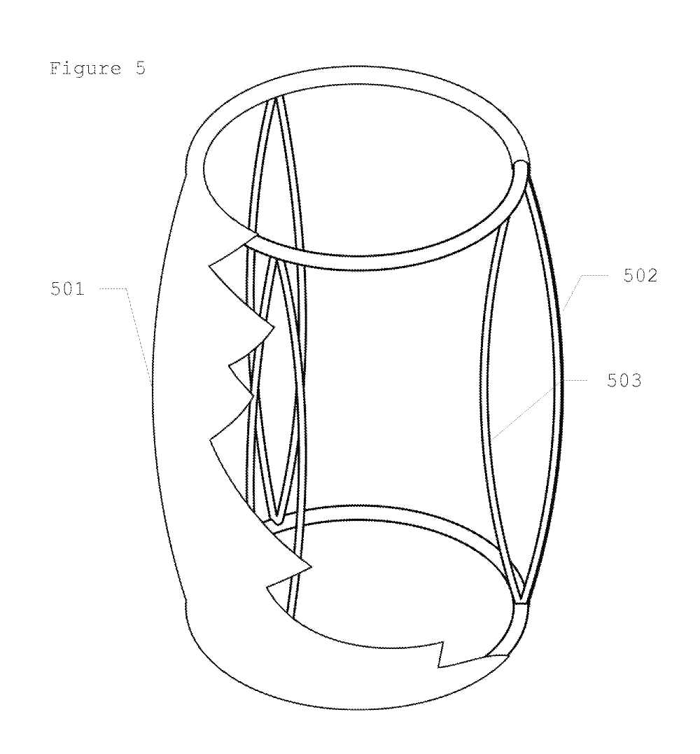

FIG. 5 is another variation of FIG. 4 but showing a portion of the CFL cover material attached to the rigid structure, showing a cutaway view. 501 depicts the CFL cover material, and again, 502 and 503 depict the outside and inside portions of the rigid structure of the CFL cover, respectively.

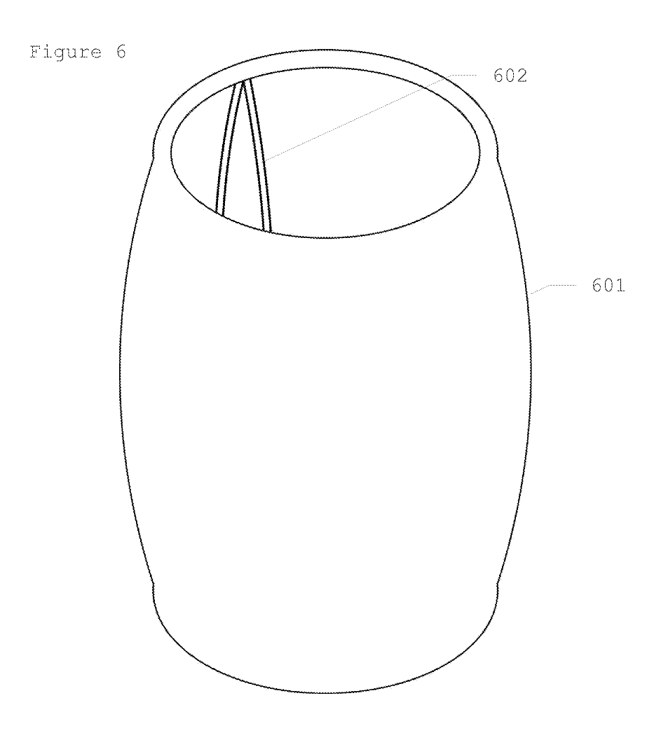

Finally, FIG. 6 is a depiction of the Detachable Cover Apparatus For Compact Fluorescent Light (CFL) Bulbs device as viewed by the user, with the CFL cover shown in 601, and a portion of the interior frame visible in 602.

What is claimed is:

1. The Detachable Cover Apparatus for Compact Fluorescent Light (CFL) Light Bulbs that is the subject of this invention provides a heat resistant, pliable or non-pliable cover that encompasses the fluorescent tube portion of the light bulb partially or in its entirety, and is held in place using a rigid frame structure that applies pressure to the exterior surface (s) of the fluorescent tube. The pliable or non-pliable cover can partially or completely cover the entire surface of the fluorescent tube portion of the light bulb, thereby serving to alter the illumination characteristics of the fluorescent light source. In the case of either full or partial covering of the CFL bulb, the CFL cover of the Detachable Cover Apparatus for Compact Fluorescent Light Bulbs device can be moved up and down along the axis of the light bulb to vary the diffusion or softening effect.

2. In a variation of claim 1, the rigidity of the outside portion of the frame structure holding the shape of a pliable cover as well as the interior portion contacting the fluorescent tubing and holding the entire invention in place, can be designed and weaved into the material itself.

3. In particular embodiments of claims 1 and 2, the pliable or non-pliable cover being of such material to cause the fluorescent light source's illumination to be softened or diffused.

4. In particular embodiments of claims 1 and 2, the pliable or non-pliable cover being of such material to cause the fluorescent light source's illumination color to be altered.

5. In particular embodiments of claims 1 and 2, the pliable or non-pliable cover being of such material to cause the fluorescent light source's illumination to be reflected.
